(19) United States
(12) Patent Application Publication
(10) Pub. No.: US 2004/0106409 A1
(43) Pub. Date: Jun. 3, 2004

(54) Method of handover in multimode telecommunication network

(76) Inventor: Michael Roberts, Neuilly Sur Seine (FR)

Correspondence Address: KATTEN MUCHIN ZAVIS ROSENMAN, 575 MADISON AVENUE, NEW YORK, NY, 10022-2585, US

(21) Appl. No.: 10/723,058

(22) Filed: Nov. 26, 2003

(30) Foreign Application Priority Data
Nov. 29, 2002 (FR) 0215032

(51) Int. Cl. H04Q 7/20

(52) U.S. Cl. 455/436; 455/552.1

(57) ABSTRACT

A method of handover, that is, intercellular transfer, by a mobile terminal in a multimode cellular telecommunication network in which, to initiate a handover, the network sends to the mobile terminal a first group of system information via a first channel associated with circuit switching services and a second group of system information via a second channel associated with packet switching services. The method includes the steps of: a) performing measurements at least in one neighboring cell on the basis of information contained in the second group of system information; b) sending to the network the measurements performed in step a); and c) initiating the procedure of handover according to the measurements performed in step a).

### BACKGROUND OF THE INVENTION

1. Field of the Invention

The invention is in the field of mobile telecommunications, and more specifically, it relates to a method of handover, that is intercellular transfer, in a multimode mobile telecommunication network in which, to initiate a handover, the network sends to a mobile terminal a first group of system information via a first channel associated with circuit switching services and a second group of system information via a second channel associated with packet switching services.

More particularly, the invention is applied to a GSM (Global System for Mobile communication)/GPRS (General Packet Service)-UMTS (Universal Mobile Telephone service) dual mode terminal in a multimode network comprising GMS/GPRS cells and UMTS cells.

2. Description of the Related Art

In a cellular network, a mobile terminal is connected to a particular cell of the network, which will be referred to as current cell in this description below.

To prepare for a handover, the network has to present the mobile terminal with a list of the neighboring cells in which the access technology is the same as the one implemented in the current cell, and also of the cells in which a different access technology is implemented.

The technical specifications of 3GPP (Third Generation Partnership Project) define for the GSM standard a unidirectional logical control channel on the downlink BCCH (Broadcast Control Channel) for sending the mobile terminal system information being broadcast in a cell.

This system information is called SYSTEM INFORMATION TYPE 2 (S12) in circuit switching networks and SYSTEM INFORMATION TYPE 5 (S15) in packet switching networks.

With the introduction of GPRS, a new unidirectional logical control channel on the downlink PBCCH (Packet Broadcast Control Channel) was defined to send to the mobile terminal various types of system information being broadcast in a cell. This system information contains among other things a list of frequencies of the neighboring cells in which measurements have to be performed.

In the prior art, when the terminal establishes communication with the network, a dedicated channel SDCCH (Slow Dedicated Control Channel) is allocated to the sending of system information.

However, a delay required for sending this information is relatively long (3 to 4 seconds). Consequently, success of a procedure of handover may be compromised since this procedure has to be achieved within a shorter delay especially in the case of saturation of the current cell.

This problem becomes aggravated by the fact that the current specifications of the 3GPP standard do not provide a procedure that permits the mobile terminal to send to the network the results of measurements performed on the basis of system information transmitted over an available PBCCH channel.

### SUMMARY OF THE INVENTION

The object of the invention is to alleviate the disadvantages of the prior art described above.

The invention proposes a method of handover (i.e., intercellular transfer) in a multimode mobile telecommunication network in which, to initiate a handover, the network sends to a mobile terminal a first group of system information via a circuit switching channel and a second group of system information via a packet switching channel. The circuit switching channel is a channel associated with circuit switching services and the packet switching channel is a channel associated with packet switching services.

The method according to the invention comprises the steps of:

a) performing measurements at least in one neighboring cell on the basis of information contained in the second group of system information,

b) sending the network the measurements performed in step a), and

c) initiating the handover according to the measurements performed in step a).

In a particular application of the invention, the measurements are performed in a neighboring cell of circuit switching (CS) type.

Preferably, the invention is applied in a GSM/GPRS dual mode network and in a UMTS network. In this case, the first channel is BCCH channel and the second channel is PBCCH channel.

The invention also relates to a mobile terminal which performs measurements for preparing for a handover in a mobile telecommunication network. This measurements depend either on a first group of system information sent by the network to the mobile terminal via a circuit switching channel or on a second group of system information sent by the network to the mobile terminal via a packet switching channel.

The mobile terminal according to the invention further comprises:

means for performing measurements at least in one neighboring cell on the basis of information contained in the second group of system information,

means for sending the network the measurements performed, and

means for initiating the procedure of handover according to the measurements performed.

According to the present invention, the procedure of handover is surely performed since the measurements performed in a neighboring cell on the basis of the system information are rapidly sent to the network.

Other characteristics and advantages of the invention will be apparent from the following description, made by way of non-limiting example, with reference to accompanying drawings.

### BRIEF DESCRIPTION OF THE DRAWINGS

FIG. 1 is a view schematically illustrating the steps of the method according to the invention, and

FIG. 2 is a block diagram illustrating the mobile terminal according to the invention.

### DETAILED DESCRIPTION OF THE PREFERRED EMBODIMENTS

In order to disclose the invention, the following description relates to an implementation of the method in a GSM/GPRS network in which a mobile terminal MS (for mobile station) is located in a saturated cell of the GSM network. Therefore, a procedure of handover regarding the mobile terminal from the saturated cell towards a cell comprising sufficient radio resources for continuing the communication has to be implemented. Measurements are performed for identifying a neighboring cell having the sufficient radio resources.

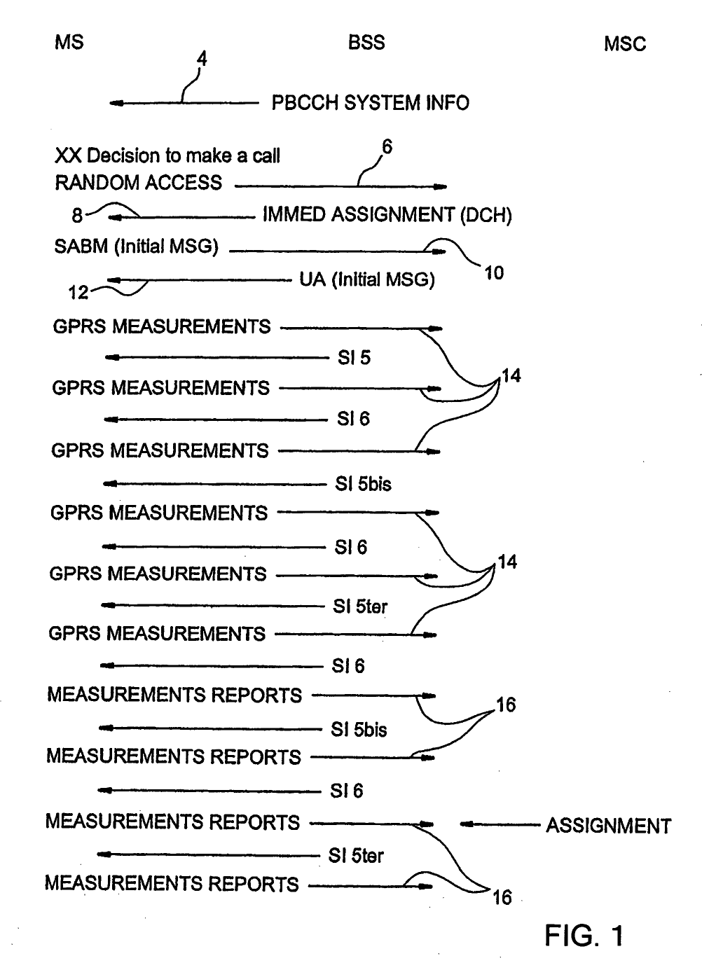

FIG. 1 describes the various steps of this procedure by indicating with arrows various information exchanged among the mobile terminal (MS), a base station system (BSS) and a mobile switching center (MSC).

In a known manner, the BSS access network sends, as indicated by arrow 4, mobile terminal MS a first list of frequencies with regard to the cells to be measured via the BCCH channel and second list of frequencies with regard to the cells to be measured via the PBCCH channel.

To establish the communication, the terminal sends, as indicated by arrow 6, to the BSS a request for connection to the network.

Upon receiving this request, the BBS immediately allocates, as indicated by arrow 8, to the terminal a bidirectional transport channel SDCCH that conveys data from the user of the terminal and signaling information. The terminal then exchanges initialization messages (Initial MSG) with the BSS as indicated by arrows 10 and 12.

Contrary to the procedure of handover in the prior art, the terminal immediately sends, as indicated by arrows 14 to the BSS GPRS measurements based on the system information sent via the PBCCH without waiting for the reception of the system information S15 sent via the BCCH channel.

In the example shown in FIG. 1, the terminal sends six reports of measurements as indicated by arrows 14 before measurements are carried out on the basis of the messages S15. Therefore, the network may prepare for the handover as indicated by arrow 16 on the basis of nine reports of measurements based on GPRS system information and GSM system information.

The procedure of handover is notably improved taking into consideration the system information supplied to the terminal via the PBCCH to the extent that the decision to perform a handover is taken on the basis of nine measurement reports instead of three.

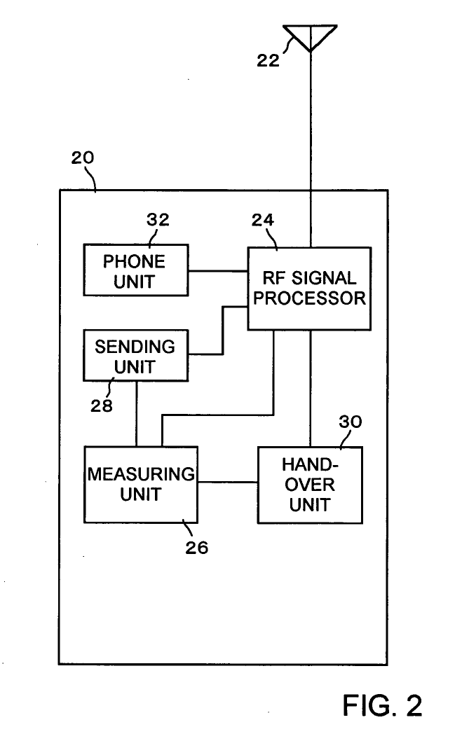

FIG. 2 shows an example of the mobile terminal according to the invention.

Mobile terminal 30 is a used in a multimode mobile telecommunication network, and performs measurements for preparing for a handover in the network. The measurements depend either on a first group of system information sent by the network to mobile terminal 20 via a circuit switching channel or on a second group of system information sent by the network to the mobile terminal 20 via a packet switching channel. The mobile terminal has antenna 22, RF signal processor 24 connected to antenna 22, measuring unit 26 for performing measurements at least in one neighboring cell on the basis of information contained in the second group of system information, sending unit 28 for sending to the network the measurements performed in measuring unit 26, handover unit 30 for initiating the procedure of handover according to the measurements performed in measuring unit 26, and phone unit 32 which realizes general functions of a cellular phone such as dialing and voice communication. Each of measuring unit 26, sending unit 28, handover unit 30 and phone unit 32 is connected to RF signal processor 24.

While a preferred embodiment of the present invention has been described using specific terms, such description is for illustrative purposes only, and it is to be understood that changes and variations may be made without departing from the spirit or scope of the following claims.

What is claimed is:

1. A method of handover in a multimode mobile telecommunication network in which, to initiate a handover, the network sends to a mobile terminal a first group of system information via a first channel associated with circuit switching services and a second group of system information via a second channel associated with packet switching services, comprising the steps of:
a) performing measurements at least in one neighboring cell on a basis of information contained in the second group of system information,
b) sending to the network the measurements performed in step a), and
c) initiating the procedure of handover according to the measurements performed in step a).

2. The method according to claim 1, wherein the measurements are performed in a neighboring cell of circuit switching (CS) type.

3. The method according to claim 2, wherein the telecommunication network is a GSM/GPRS network, and wherein the first channel is a BCCH channel and the second channel is a PBCCH channel.

4. The method according to claim 2, wherein the telecommunication network is a UMTS network.

5. A mobile terminal used in a multimode mobile telecommunication network, the mobile terminal performing measurements for preparing for a handover in the network, the measurements depending either on a first group of system information sent by the network to the mobile terminal via a circuit switching channel or on a second group of system information sent by the network to the mobile terminal via a packet switching channel, the mobile terminal comprising:
means for performing measurements at least in one neighboring cell on a basis of information contained in the second group of system information,
means for sending to the network the measurements performed, and
means for initiating the procedure of handover according to the measurements performed.
